(19) United States
(12) Patent Application Publication
(10) Pub. No.: US 2010/0065600 A1
(43) Pub. Date: Mar. 18, 2010

(54) Auto-breaking machine

(76) Inventors: Xiao-Lin Wu, Tu-Cheng City (TW); Sung-Lin Chen, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,331

(22) Filed: Sep. 16, 2008

(51) Int. Cl. B26F 3/00

(52) U.S. Cl. 225/97; 225/98

(57) ABSTRACT

An auto-breaking machine adapted for breaking metal shells off a base band includes a frame assembly, a first breaking assembly, a power assembly and a turntable. The first breaking assembly has a support assembly disposed on the frame assembly, a first breaking member and a second breaking member pivoted on the support assembly and spaced away from each other for allowing the base band passing therebetween. The second breaking member has a breaking portion at a free end thereof and keeps a distance from a free end of the first breaking member for breaking the metal shells off the base band. The power assembly is disposed on the frame assembly. The turntable is rotatably mounted to the power assembly and driven by the power assembly for driving the base band to move.

### BACKGROUND OF THE INVENTION

1. Field of the Invention

The present invention relates to a breaking machine, and more particularly to an auto-breaking machine.

2. The Related Art

Traditionally, a plurality of metal shells is connected on a base band before being used to facilitate the storage. In use, the metal shells are broken off the base band by hand. However, breaking the metal shells off the base band by hand suffers from low work efficiency and also unnecessarily wastes a great deal of manpower. Furthermore, the metal shells are apt to injure hands of operators because of a great deal of burrs formed around the metal shells. Therefore, an auto-breaking machine which overcomes aforementioned problems and is capable of automatically breaking the metal shells off the base band is required.

### SUMMARY OF THE INVENTION

An object of the present invention is to provide an auto-breaking machine adapted for breaking metal shells off a base band. The auto-breaking machine includes a frame assembly, a first breaking assembly, a power assembly and a turntable. The first breaking assembly has a support assembly disposed on the frame assembly, a first breaking member and a second breaking member pivoted on the support assembly and spaced away from each other for allowing the base band passing therebetween. The second breaking member has a breaking portion at a free end thereof and keeps a distance from a free end of the first breaking member for breaking the metal shells off the base band. The power assembly is disposed on the frame assembly. The turntable is rotatably mounted to the power assembly and driven by the power assembly for driving the base band to move.

As described above, the auto-breaking machine can break the metal shells off the base band automatically by way of the breaking portion acting the pressure on the metal shells during the base band moving. Therefore, the auto-breaking machine can improve work efficiency and save a great deal of manpower.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of an auto-breaking machine in accordance with an exemplary embodiment of the present invention;

FIG. 2 is a perspective view of a frame assembly of the auto-breaking machine of FIG. 1, wherein a first breaking assembly is disposed therein;

FIG. 3 is an exploded perspective view of the first breaking assembly and a second breaking assembly of FIG. 1;

FIG. 4 is a perspective view of the first breaking assembly and the second breaking assembly of FIG. 3; and

FIG. 5 is a perspective view of the auto-breaking machine of FIG 1, wherein the auto-breaking machine is working and a plurality of preventing boards is omitted.

### DETAILED DESCRIPTION OF THE PREFERRED EMBODIMENT

Referring to FIG. 1, an auto-breaking machine of the present invention is shown. The auto-breaking machine includes a frame assembly 1, a first breaking assembly 2, a second breaking assembly 3, a feeding assembly 4, a power assembly 5, a first turntable 6 and a second turntable 7.

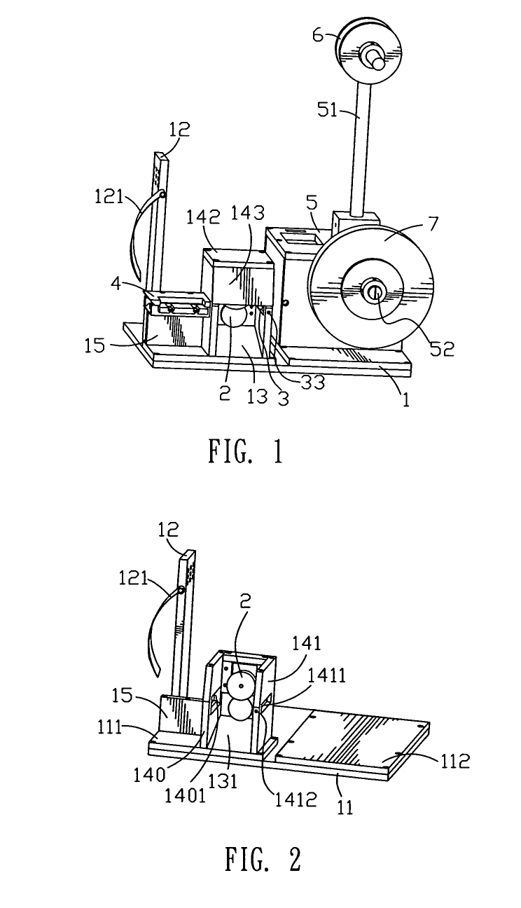

Referring to FIG. 1 and FIG. 2, the frame assembly 1 has a rectangular base board 11 disposed levelly. A rectangular first padding board 111 is fixed on a left front portion of the base board 11 and a rectangular second padding board 112 is fixed on a right portion of the base board 11. A rectangular assistant board 12 is vertically fixed on a left rear portion of the base board 11 along a longitudinal direction and an arched guiding flake 121 is freely fixed on a front end of the assistant board 12. A rectangular support board 15 is vertically fixed on a left rear portion of the first padding board 111 along a longwise direction. The feeding assembly 4 is fixed on a top portion of the support board 15 and under the guiding flake 121. The power assembly 5 is fixed on a rear of the second padding board 112 and has a drive shaft 52 stretching out of a front of the power assembly 5. The first turntable 6 is rotatably disposed above the power assembly 5 via a vertical rod 51 and the second turntable 7 is fixed to the drive shaft 52 so as to be driven by the power assembly 5 to rotate. The first turntable 6, the second turntable 7 and the guiding flake 121 are located on a vertical plane.

The frame assembly 1 further includes a first preventing board 140, a second preventing board 141, a third preventing board 142 and a fourth preventing board 143 which are rectangular. The first preventing board 140 and the second preventing board 141 are vertically fixed on a right of the first padding board 111 facing each other. The first preventing board 140 lies in a left of the second preventing board 141 and abuts against a right end of the support board 15. The first preventing board 140 defines a first fixing window 1401 transversely passing therethrough and a right end of the feeding assembly 4 is inserted in the first fixing window 1401. The second preventing board 141 defines a second fixing window 1411 facing to the first fixing window 1401 and a connecting perforation 1412 at front extending rearward to communicate with the second fixing window 1411. The fourth preventing board 143 is fixed on the front of the first preventing board 140 and the second preventing board 141 at top. The third preventing board 142 is horizontally fixed on the first preventing board 140, the second preventing board 141 and the fourth preventing board 143. A guiding block 13 is fixed on the first padding board 111 between the first preventing board 140 and the second preventing board 141. Two sides of the guiding block 13 respectively abut against the first preventing board 140 and the second preventing board 141. A top surface 131 of the guiding block 13 gradually inclines downward from rear to front.

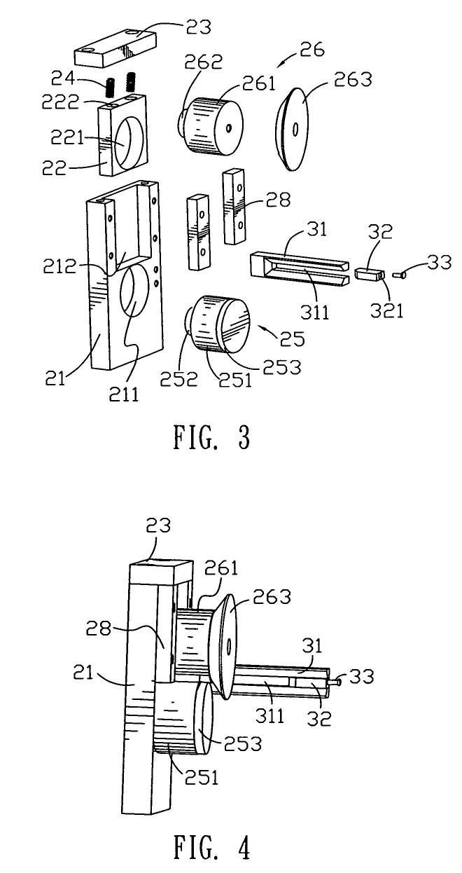

Referring to FIGS. 1-4, the first breaking assembly 2 includes a support holder 21, an adjusting slide 22, a preventing plate 23, two springs 24, a first breaking member 25, a second breaking member 26 and two preventing panels 28. The support holder 21 is rectangular and vertically fixed on a right rear of the first padding board 111 to abut against the first preventing board 140, the second preventing board 141 and the guiding block 13. A front of the support holder 21 defines a rectangular guiding chute 212 at top and a cylindrical first locating hole 211 under the guiding chute 212. The adjusting slide 22 is movably disposed in the guiding chute 212 and defines a cylindrical second locating hole 221 penetrating from front to rear. A top of the adjusting slide 22 defines two locating grooves 222. The preventing plate 23 is fixed on a top of the support holder 21 and abuts against a bottom of the third preventing board 142. One end of each of the springs 24 is received in the corresponding locating groove 222 and the other end thereof always abuts against a bottom of the preventing plate 23. The preventing panels 28 are fixed on a front of the support holder 21 and respectively adjacent to two sides of the guiding chute 212. Accordingly, the support holder 21, the adjusting slide 22, the preventing plate 23, the springs 24 and the preventing panels 28 together define a support assembly

The first breaking member 25 has a cylindrical first base portion 251, a first pivoting portion 252 extending rearward from a middle of the first base portion 251, and a guiding portion 253 extending forward from the first base portion 251 and gradually shortening in diameter. The first pivoting portion 252 is pivoted in the first locating hole 211 and the first base portion 251 is located above the guiding block 13. The second breaking member 26 has a cylindrical second base portion 261, a second pivoting portion 262 extending rearward from a middle of the second base portion 261, and a breaking portion 263. The second pivoting portion 262 is pivoted in the second locating hole 221, and the second base portion 261 lies above the first base portion 251 and is apart from the first base portion 251. The breaking portion 263 is fixed on a front of the second base portion 261 and diameters thereof are gradually increased from rear to front. The breaking portion 263 is apart from a front of the guiding portion 253.

The second breaking assembly 3 includes a rectangular assistant body 31, a preventing block 32 and an adjusting pin 33. The assistant body 31 is fixed in the second fixing window 1411 and defines a receiving window 311 passing through a front and two sides thereof. The preventing block 32 is movably received in the receiving window 311 and defines a receiving fillister 321 at front. A rear end of the adjusting pin 33 passes through the connecting perforation 1412 to be screwed into the receiving fillister 321, whereby the preventing block 32 can be adjusted to move forward or rearward in the receiving window 311 by way of turning around the adjusting pin 33.

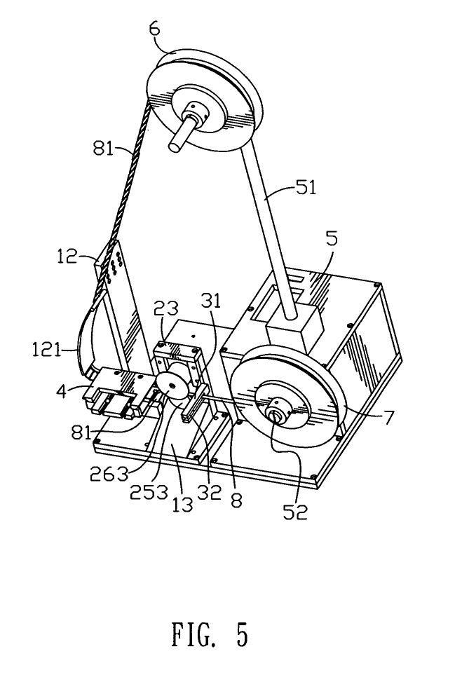

Referring to FIG. 1 and FIG. 5, in use, a free end of a base band 8 on the first turntable 6 is guided by the guiding flake 121 to pass through the feeding assembly 4, a gap between the breaking members 25, 26 and the receiving window 311 to be enwound around the second turntable 7. Then the power assembly 5 is started to drive the drive shaft 52 and the second turntable 7 to rotate and further drive the base band 8 to move. During the base band 8 moving, metal shells 81 formed on a side of the base band 8 can be continuously broken off the base band 8 because of the pressure acted on the metal shells 81 by the breaking portion 263. Furthermore, the preventing block 32 can be adjusted to move forward or rearward according to a width of the base band 8 so as to further break the remained metal shells 81 off the base band 8. The guiding portion 253 and the breaking portion 263 cooperate with each other to facilitate the metal shells 81 to be broken off the base band 8. When the thickness of the base band 8 changes, the springs 24 have a deformation so as to make the adjusting slide 22 and the second breaking member 26 move correspondingly to ensure that the first breaking member 25 and the second breaking member 26 always clip the base band 8 tightly. At the same time, the preventing boards 140, 141, 142, 143 can prevent the metal shells 81 broken off the base band 8 from flying randomly and the guiding block 13 can guide the metal shells 81 to slip downward so as to be easily collected together.

As described above, the auto-breaking machine of the present invention can break the metal shells 81 off the base band 8 automatically by way of the breaking portion 263 acting the pressure on the metal shells 81 during the base band 8 moving. Therefore, the auto-breaking machine can improve work efficiency and save a great deal of manpower.

What is claimed is:

1. An auto-breaking machine adapted for breaking metal shells off a base band, comprising:
a frame assembly;
a first breaking assembly, the first breaking assembly having a support assembly disposed on the frame assembly, a first breaking member and a second breaking member pivoted on the support assembly and spaced away from each other for allowing the base band passing therebetween, the second breaking member having a breaking portion at a free end thereof and keeping a distance from a free end of the first breaking member for breaking the metal shells off the base band;
a power assembly disposed on the frame assembly; and
a turntable rotatably mounted to the power assembly and driven by the power assembly for driving the base band to move.

2. The auto-breaking machine as claimed in claim 1, wherein the second breaking member has a cylindrical second base portion and a second pivoting portion extending rearward from the second base portion, the second pivoting portion is pivoted in the support assembly, the breaking portion is fixed on a front of the second base portion and diameters thereof are gradually increased from rear to front.

3. The auto-breaking machine as claimed in claim 2, wherein the first breaking member has a cylindrical first base portion and a first pivoting portion extending rearward from the first base portion, and the first pivoting portion is pivoted in the support assembly.

4. The auto-breaking machine as claimed in claim 3, wherein the first breaking member further has a guiding portion extending forward from the first base portion and gradually shortening in diameter.

5. The auto-breaking machine as claimed in claim 1, wherein the support assembly includes a support holder, an adjusting slide, a preventing plate and at least one elastic element, the support holder is fixed on the frame assembly and defines a guiding chute at front and top, the support holder further defines a first locating hole under the guiding chute for pivoting the first breaking member therein, the adjusting slide is movably disposed in the guiding chute and defines a second locating hole for pivoting the second breaking member therein, the preventing plate is fixed on a top of the support holder, the elastic element is located between the adjusting slide and the preventing plate.

6. The auto-breaking machine as claimed in claim 1, further comprising a second breaking assembly, the second breaking assembly has an assistant body, a preventing block and an adjusting pin, the assistant body is disposed on the frame assembly and defines a receiving window facing the breaking members of the first breaking assembly, the preventing block is movably received in the receiving window, one end of the adjusting pin is screwed into the preventing block for adjusting the preventing block to move forward or rearward in the receiving window.

7. The auto-breaking machine as claimed in claim 1, wherein the frame assembly includes a plurality of preventing boards for enclosing the first breaking assembly therein.

8. The auto-breaking machine as claimed in claim 1, wherein the frame assembly further includes a guiding block gradually inclining downward from rear to front, the guiding block is disposed under the breaking members and abuts against the support assembly at a rear thereof.
